(19) United States
(12) Patent Application Publication
(10) Pub. No.: US 2009/0115162 A1
(43) Pub. Date: May 7, 2009

(54) Pull-Rite

(76) Inventors: Brett J. Lybrook, Las Vegas, NV (US); Michele R. Lybrook, Las Vegas, NV (US)

Correspondence Address: GALASSO & ASSOCIATES, LP, P.O. BOX 26503, AUSTIN, TX, 78755-0503, US

(21) Appl. No.: 11/983,080

(22) Filed: Nov. 7, 2007

(51) Int. Cl. B60D 1/07

(52) U.S. Cl. 280/417.1

(57) ABSTRACT

Pull-Rite is an add-on device that makes a tongue ball and hitch type trailer capable of being towed with a gooseneck connection. The preferred embodiment of the invention utilizes a U-shaped base frame having a ball hitch and a lower support crossbar, adjustable vertical rails, an upper crossbar, upper bars, and a vertical down bar with a slide-in gooseneck mount or a fifth wheel pin. To use the preferred embodiment of Pull-Rite, an individual attaches the lower support cross bar of the base frame to the rear of the A-frame of a trailer. The ball hitch on the base frame is then connected to the A-frame in the traditional manner. The vertical rails can then be maneuvered to the appropriate height for use with a given tow vehicle. The downward vertical bar is then attached to the tow vehicle using the slide-in gooseneck mount or a fifth wheel pin to allow the trailer to be easily and safely towed.

### CROSS REFERENCE TO RELATED APPLICATIONS

This United States Non-Provisional Patent Application does not claim priority to any United States Provisional Patent Application or any foreign patent application.

### FIELD OF THE DISCLOSURE

The disclosures made herein relate generally to the towing accessories industry. The invention discussed herein is in the general classification of trailer towing devices.

### BACKGROUND

Outdoor recreational activities are enjoyed by millions of people around the world. Among these activities are hunting, fishing, boating, hiking, rock climbing, and camping. Some of these activities are enjoyed as combined pursuits. Hunters may, for example, set up a long-term camp as a part of their outdoor experience. Hiking and camping are also popular as joint activities.

Trailers of all types are popular accessories for many outdoor activities. Trailers are also used to transport many different materials and other items. Trailers are used for camping, moving animals such as horses and transporting boats. There are utility trailers and open and closed trailers. Some of these trailers use a ball and hitch type connection while others use a gooseneck type connection. A special connector must be purchased in order to use either one, as they are not interchangeable. Otherwise, a user must purchase and store two different types of trailers or tow vehicles to be able to tow different types of trailers.

Hence, there is a need in the art for a convenient to use, inexpensive, durable, safe and effective device that allows a tongue ball and hitch type trailer to be towed with a gooseneck connection.

### SUMMARY OF THE DISCLOSURE

Pull-Rite is an add-on device that makes a tongue ball and hitch type trailer capable of being towed with a gooseneck connection.

The preferred embodiment of the invention utilizes a base frame having a ball hitch and a lower support crossbar, adjustable vertical rails, an upper crossbar, upper bars, and a vertical down bar with a slide-in gooseneck mount or a fifth wheel pin.

Certain embodiments of the invention may utilize adjustable, telescoping tubing for virtually all of the components to allow the device to fit virtually any tow vehicle and trailer. In addition, certain embodiments may have a pivoting version of the device with wheels for ease of use and storage.

The principal object of this invention is to provide a device for towing a tongue ball and hitch type trailer with a gooseneck connection.

Another object of this invention is to provide a towing device that provides even weight transfer between the towing vehicle and the trailer.

Another object of this invention is to provide a towing device to enhance maneuverability when a towing vehicle is attached to a trailer.

Another object of this invention is to provide a towing device to enhance stability when a towing vehicle is attached to a trailer.

Another object of this invention is to provide a towing device to augment towing capacity when a towing vehicle is attached to a trailer.

Another object of this invention is to provide an affordable device for towing a tongue ball and hitch type trailer with a gooseneck connection.

Another object of this invention is to provide a safe device for towing a tongue ball and hitch type trailer with a gooseneck connection.

Yet another object of this invention is to provide a durable device for towing a tongue ball and hitch type trailer with a gooseneck connection.

### BRIEF DESCRIPTION OF THE DRAWINGS

FIG. 1 depicts a perspective view of the preferred embodiment of the present invention.

FIG. 2 depicts a top view of the preferred embodiment of the present invention.

FIG. 3 depicts a cross-sectional view cut along the line A-A of FIG. 1.

### DETAILED DESCRIPTION OF THE DRAWINGS

The preferred embodiment of Pull-Rite is comprised of at least some of the following: a U-shaped base frame having a ball hitch and a lower support crossbar, adjustable vertical rails, an upper crossbar, upper bars, and a vertical down bar with a slide-in gooseneck mount or a fifth wheel pin.

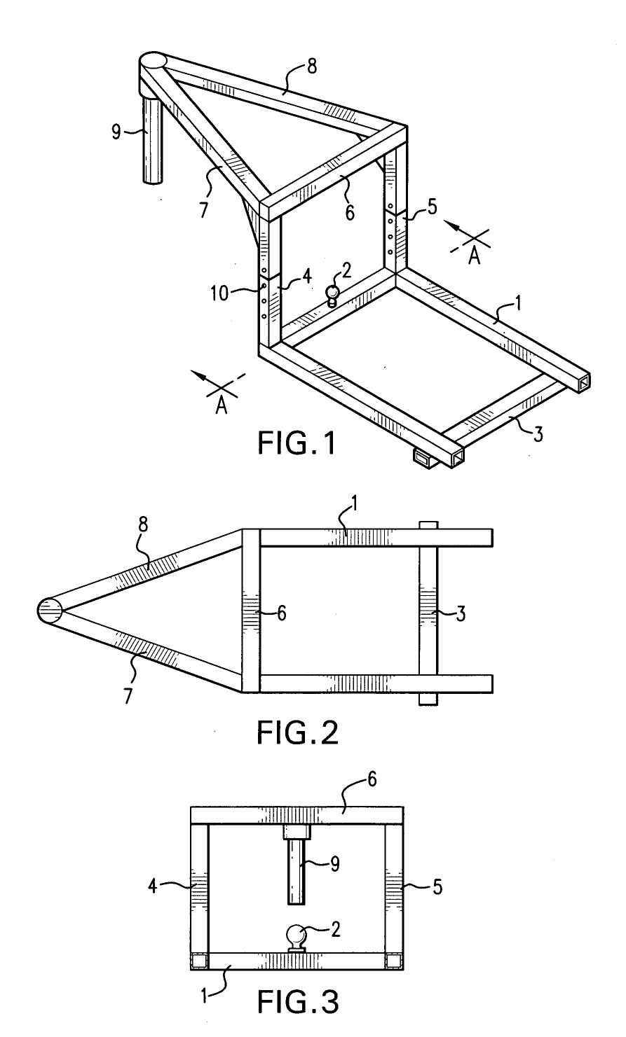

FIG. 1 depicts a perspective view of the preferred embodiment of the present invention. The bottom of the device has a base frame 1 with a U-shape. The base frame 1 is three feet in length and eight and one half feet in width and made of steel in this preferred embodiment though a variety of materials and sizes are possible. A ball hitch (tongue ball) 2 is centrally located on the top and rear of the base frame 1. The ball hitch 2 is also made of steel in this preferred embodiment.

Other embodiments of the ball hitch may have it connected to the base frame with a telescoping tubing having pin holes to permit it to be moved forward to accommodate different size trailers.

In certain embodiments of the base frame, the rear of the base frame having the ball hitch can be moved along the sides of the base frame and locked into place using pin holes on the sides of the base frame. For example, pin holes could be located every six inches for two feet along the sides of the base frame and the rear of the base frame can slide along the sides of the base frame.

A lower support crossbar 3 is located on the front and bottom of the base frame 1 connecting the opposite sides of the preferred embodiment. In certain embodiments, pin holes could be utilized to permit the lower support crossbar to be moved along the sides of the base frame. The lower support crossbar could also have two mounting brackets on top that permit it to be attached to the A-frame of a trailer.

A first vertical rail 4 and a second vertical rail 5 connect to opposite sides of the base frame 1. The first vertical rail 4 and the second vertical rail 5 are adjustable from three feet to six feet in this preferred embodiment to accommodate lifted trucks. The first vertical rail 4 and the second vertical rail 5 have a telescoping design with four pin holes 10 located through them to allow adjustment in this preferred embodiment.

An upper crossbar 6 connects the first vertical rail 4 and the second vertical rail 5. A first upper bar 7 and a second upper bar 8 are connected to the upper crossbar 6 and the first vertical rail 4 and the second vertical rail 5. The first upper bar 7 and the second upper bar 8 form a triangular shape with the upper crossbar 6. The first upper bar 7 and the second upper bar 8 extend six feet from the first vertical rail 4 and the second vertical rail 5.

A vertical downward bar 9 at the end of the first upper bar 7 and the second upper bar 8 extends approximately two feet toward the base frame 1. The vertical downward bar 9 is approximately cylindrical in shape in this preferred embodiment. The vertical downward bar 9 is dimensioned to accommodate a slide-in gooseneck mount or a fifth wheel pin. In alternative embodiments of the invention, the vertical downward bar may be rectangular instead of cylindrical and may be bolted or welded to a plate at the end of the first upper bar and the second upper bar. In certain embodiments, mounting bolts at two different locations on the vertical downward bar provide adjustability and permit the gooseneck or fifth wheel pin to be moved vertically at least six inches.

The base frame 1, lower support crossbar 3, upper crossbar 6, first upper bar 7 and second upper bar 8 are constructed of four inch square metal stock tubing though a variety of other sized and shaped tubing could also be utilized. In the preferred embodiment, the first vertical rail 4 and the second vertical rail 5 are constructed such that the inside width of a portion of the vertical rails is four inches while the outside width of a portion of the vertical rails is four inches to permit telescoping.

FIG. 2 depicts a top view of the preferred embodiment of the present invention. The base frame 1, lower support crossbar 3, upper crossbar 6, first upper bar 7 and second upper bar 8 are all visible from this view.

FIG. 3 depicts a cross-sectional view cut along the line A-A of FIG. 1. The base frame 1, the ball hitch 2, the first vertical rail 4, the second vertical rail 5, the upper crossbar 6, and the vertical downward bar 9 are all visible in this view. The relative lengths of these components can be seen for the preferred embodiment.

Certain alternative embodiments of the invention may utilize a variety of attachments to make moving and installing the device easier. For example, pivots could be attached to the sides of the A-frame of the trailer and be dimensioned to connect with the front of the base frame. Removable wheels located on the rear of the base frame allow the device to be easily positioned and attached to the pivots. An electronic jack or hydraulic jack could be utilized to raise the rear of the base frame once the front of the base frame is connected to the pivots on the A-frame of the trailer. After use of the pivots, wheels and jack, the ball hitch could be connected as usual and the wheels could be removed for towing.

To use the preferred embodiment of Pull-Rite, an individual attaches the lower support cross bar of the base frame to the rear of the A-frame of a trailer. The ball hitch on the base frame is then connected to the A-frame in the traditional manner. The vertical rails can then be maneuvered to the appropriate height for use with a given tow vehicle. The downward vertical bar is then attached to the tow vehicle using the slide-in gooseneck mount or a fifth wheel pin to allow the trailer to be easily and safely towed.

Pull-Rite attaches to a tongue type trailer making it capable of being towed by semis, lifted trucks, or any vehicle with a gooseneck type connection. It can be used on all types of trailers such as horse, livestock, utility, flatbeds, car haulers, and campers. It permits the transfer of weight from a ball type hitch to a gooseneck type hitch, providing better maneuverability, stability and handling. Different versions of the invention can accommodate varying trailer weights. A light duty version of the invention for use on small pick-up trucks, cars or sports utility vehicles may be seven feet wide and capable of towing under 7500 pounds. A medium duty version of the invention for use on three to four ton trucks may be eight feet wide and capable of towing between 7,500 and 10,000 pounds. A heavy duty version of the invention for use with semis may be eight and a half feet wide and capable of towing loads in excess of 15,000 pounds.

The materials utilized for Pull-Rite and its accessories may vary widely but will likely include metals, plastics and electronic components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Pull-Rite can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

All electronic components of the invention will also be ideally selected from those currently having the highest industry ratings. These components will also meet and/or exceed all safety and usage regulations. Wiring and associated connecting hardware should be insulated and otherwise protected from intrusion by any harmful or degrading elements, including water, medium level temperatures, and low to medium impact force.

It should be obvious that the components of the present invention can be of various shapes and sizes. It should also be obvious that the components of the invention can be made of different types of metals, plastics or other suitable materials and can be of any color.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A towing device comprising:
(a) a base frame having a ball hitch;
(b) a first vertical rail and a second vertical rail connected to opposite sides of the base frame; and
(c) a downward vertical bar operatively connected to the first vertical rail and the second vertical rail.

2. The device of claim 1 wherein the base frame has a U-shape with a rear section and a first side and a second side.

3. The device of claim 2 wherein the ball hitch is centrally located on the rear section of the base frame.

4. The device of claim 1 wherein the ball hitch connects to the base frame with a telescoping tubing having a plurality of pin holes.

5. The device of claim 3 wherein the rear section of the base frame slides along the first side and the second side of the base frame.

6. The device of claim 5 wherein a first pin hole is located six inches from a second pin hole that is located six inches from a third pin hole along the top of the first side of the base frame and a fourth pin hole is located six inches from a fifth pin hole that is located six inches from a sixth pin hole along the top of the second side of the base frame.

7. The device of claim 2 further comprising
a lower support crossbar located on the front of the base frame connecting the first side and the second side of the base frame.

8. The device of claim 7 wherein a first plurality of pin holes is located toward the front of the first side of the base frame and a second plurality of pin holes is located toward the front of the second side of the base frame while the lower crossbar is dimensioned to permit it to slide along and lock into the first side and the second side of the base frame.

9. The device of claim 7 wherein the lower support crossbar has a mounting bracket.

10. The device of claim 1 wherein the first vertical rail and the second vertical rail are adjustable.

11. The device of claim 10 wherein the first vertical rail and the second vertical rail telescope and have a plurality of pin holes.

12. The device of claim 1 further comprising
an upper crossbar connecting the first vertical rail and the second vertical rail.

13. The device of claim 12 further comprising
a first upper bar and a second upper bar attached to the vertical downward bar and connected to the upper crossbar while forming a triangular shape with the upper crossbar.

14. The device of claim 1 wherein the vertical downward bar accommodates a slide-in gooseneck mount.

15. The device of claim 1 wherein the vertical downward bar accommodates a fifth wheel pin.

16. The device of claim 1 wherein a first mounting hole and a second mounting hole are located six inches apart on the vertical downward bar.

17. The device of claim 2 wherein a first pivot and a second pivot attaches to the sides of a trailer and to the first side and the second side of the base frame.

18. The device of claim 2 further comprising
a set of removable wheels attached to the rear section of the base frame.

19. A towing device comprising:
(a) a base frame with a rear section, a first side and a second side forming a U-shape in which the rear section slides over the first side and the second side;
(b) a ball hitch connected to approximately the center of the rear section via a telescoping tubing with a first plurality of pin holes;
(c) a first adjustable vertical rail and a second adjustable vertical rail connected to opposite sides of the rear section;
(d) a second plurality of holes located along the top of the first side and a third plurality of holes located along the top of the second side to permit the rear section to be connected;
(e) a lower support crossbar that slides over and connects to the first side and the second side of the base frame via a fourth plurality of holes located on the top of the first side and a fifth plurality of holes located on the top of the second side;
(f) a first mounting bracket and a second mounting bracket located on top of the lower support crossbar;
(g) an upper crossbar connecting the top of the first adjustable vertical rail and the second adjustable vertical rail;
(h) a first upper bar and a second upper bar attached to a vertical downward bar and connected to the upper crossbar while forming a triangular shape with the upper crossbar; and
(i) a slide-in gooseneck mount attachable to the vertical downward bar.
